(19) United States
(12) Patent Application Publication
(10) Pub. No.: US 2026/0285655 A1
(43) Pub. Date: Sep. 24, 2026

(54) Lifting System for Lifting a Vehicle Comprising a Data Aggregation System and Methods for Lifting Such Vehicle

(71) Applicant: Stertil B.V., Kootstertille (NL)

(72) Inventors: Hilbrand Jan Kamminga, Kootstertille (NL); Albert Thaeke Russchen, Kootstertille (NL)

(21) Appl. No.: 19/490,860

(22) PCT Filed: May 24, 2024
(86) PCT No.: PCT/NL2024/050265

§ 371 Date: Dec. 5, 2025

(30) Foreign Application Priority Data
Jun. 8, 2023 (NL) 2035036

(51) Int. Cl. B66F 7/00; G05B 15/02

(52) U.S. Cl. CPC B66F 7/00; G05B 15/02

(57) ABSTRACT

The present invention relates to a lifting system for lifting a vehicle including a data aggregation system and methods for lifting such vehicle. The lifting system according to the invention includes
at least one lifting device with a carrier and a drive system configured for lifting the vehicle;
a control system configured for controlling the at least one lifting device, with the control system including
   a data aggregation system configured to collect a plurality of measurements at a time (T);
   a data processing unit that is operatively connected to the data aggregation system;
   a memory that is operatively connected to the data processing unit;
   a first communication module operatively connected to the data processing unit; and
a lifting data receiving system including a processor, a memory operatively connected to the processor and a second communication module operatively connected to the processor, wherein the second communication module is configured to:
   receiving one or more measurements of the plurality of measurements from the at least one lifting device; and
   sending instructions to the at least one lifting device, wherein the instructions are determined by comparing the received measurements with one or more thresholds, wherein the instructions includes at least one or more of a maintenance warning, a warning and/or lock signal, and a selection of one or more lifting devices for the lifting system.

### CROSS-REFERENCE TO RELATED APPLICATIONS

This application is the United States national phase of International Patent Application No. PCT/NL2024/050265 filed May 24, 2024, and claims priority to The Netherlands Patent Application No. 2035036 filed Jun. 8, 2023, the disclosures of which are hereby incorporated by reference in their entireties.

### BACKGROUND OF THE INVENTION

### Field of the Invention

The invention relates to a lifting system for lifting vehicles, such as passenger cars, trucks, busses and other vehicles. Such lifting system may comprise one or more lifting devices having a carrier and a drive system, such as a (mobile) lifting column, lifting column of two-post lift type with pivoting support arms, four-post lift type with runways, in-ground lifts et cetera. Such lifting system comprising at least one lifting device, and alternatively two or any other suitable number of the aforementioned lifting devices, is suitable for lifting the vehicle.

### Description of Related Art

Conventional lifting systems are operated by an operator/user that controls and monitors the lifting operation.

One of the problems with conventional lifting systems relates to the supervision of such lifting system. The supervision relates to the actual usage of the lifting system, maintenance requirements, safety concerns et cetera. This involves monitoring and checking numerous items and data. This may result in unnecessary costs for maintenance and repair. Also, this may result in undesired safety concerns.

### SUMMARY OF THE INVENTION

An object of the present invention is to obviate or at least reduce one or more of the aforementioned problems.

This object is achieved with a lifting system for lifting a vehicle according to the present invention, wherein the lifting system comprising:
at least one lifting device with a carrier and a drive system configured for lifting the vehicle;
a control system configured for controlling the at least one lifting device, with the control system comprising:
   a data aggregation system configured to collect a plurality of measurements at a time (T) from at least one or more of the following categories:
      height of the carrier;
      velocity of the carrier;
      lifting device status data comprising data relating to the status of the drive system of the at least one lifting device; and
      lifting process data comprising data relating to the lifting operation;
   a data processing unit that is operatively connected to the data aggregation system, wherein the data processing unit is configured to process each measurement of the plurality of measurements from the data aggregation system;
   a memory that is operatively connected to the data processing unit;
   a first communication module operatively connected to the data processing unit;
a lifting data receiving system comprising a processor, a memory operatively connected to the processor and a second communication module operatively connected to the processor, wherein the second communication module is configured to connect to the first communication module of the lifting system and is configured to:
   receiving one or more measurements of the plurality of measurements from the at least one lifting device; and
   sending instructions to the at least one lifting device, wherein the instructions are determined by comparing the received measurements with one or more thresholds, wherein the instructions comprise at least one or more of a maintenance warning, a warning and/or lock signal, and a selection of one or more lifting devices for the lifting system.

The control system is capable of controlling the at least one lifting device and the lifting operation of lifting a vehicle. The control system comprises a data aggregation system, a data processing unit, a memory, and a first communication module. The memory and the first communication module are operatively connected to this data processing unit. The data aggregation system and the aforementioned units can be provided as a single system/unit or as a number of connected sub-systems which optionally have separate (sub)-processes.

The data aggregation system is configured to collect a plurality of measurements at a specific moment. These measurements may involve data of one or more of the categories of height and/or velocity of the carrier, lifting device status data relating to the drive system, and lifting process data with data relating to the actual lifting operation. Height and velocity of the carrier can be measured with different sensors, including conventional sensor types. The lifting device status data may comprise data relating to the battery status, such as the minimum and/or maximum number of potential lifts before recharge is required, status of the drive cylinder(s), for example the amount of hydraulic oil and/or electric power that is used at a specific moment and/or has been used up to this moment for a specific lifting operation and/or for cumulative lifting operations after a recent maintenance operation. The lifting cylinder can be a hydraulic, electric and/or pneumatic cylinder. The lifting process data may comprise data relating to the actual lifting operation, optionally including vehicle type and/or vehicle identification, for example. The lifting process data may also comprise the number and identification of the one or more lifting devices that are actually used in this specific lifting operation.

The data processing unit is capable of processing each measurement of the plurality of measurements from the data aggregation system. The lifting process data may also comprise information about the operator/user. The data processing unit is operatively connected to the memory to store measurement data, and is operatively connected to the first communication module to enable communication of the measurement data.

The lifting system further comprises a lifting data receiving system with a processor, a memory that is operatively connected to the processor and a second communication module operatively connected to the processor. More specifically, the second communication module is configured to connect to the first communication model of the lifting system to enable receiving measurements from and/or process measurement data from the at least one lifting device and sending instructions to the at least one lifting device. The instructions are determined by the lifting data receiving system by processing the received measurements and comparing the received measurements and/or processed measurements with one or more thresholds. The instructions comprise at least one or more of a maintenance warning, a warning and/or lock signal, and a selection of one or more lifting devices for the lifting system.

A maintenance warning can be generated for several reasons. For example, a maintenance warning is generated when the actual and/or cumulative loads acting on the carrier and/or drive system are above a threshold value. Such instruction triggers a maintenance operation and maintenance can be performed on the lifting system. Optionally, the lifting system can be used for a time period and/or a number of lifting operations and/or a cumulative load before maintenance is performed, whereafter the lifting system is optionally locked.

For this purpose, in some of the embodiments according to the invention, the lifting data receiving system can be (a part of) an external system that is optionally positioned at a distance from the lifting system. Also optionally, the lifting data receiving system can be configured to receive information from more than one lifting system. In some of the presently preferred embodiments of the invention, the lifting data receiving system communicates with a maintenance provider to instruct a maintenance operation for the respective lifting system.

A warning and/or lock signal can be generated by the lifting data receiving system in case an actual load exceeds a threshold and/or when cumulative loads exceed the respective threshold. This improves safety when working with the lifting system and specifically reduces the risk of malfunctioning of the lifting system due to failure, fatigue et cetera. A warning signal can be sent to an operator/user and/or supervisor and/or the lifting system. Optionally, a warning signal is combined with a lock signal that actively locks the lifting system. Optionally, a lock signal is communicated directly to the lifting system in case of exceeding a respective threshold.

Instructions can also be generated or provided when selecting one or more lifting devices for the lifting system. For example, when selecting mobile lifting columns for a group of lifting columns together defining a lifting system for lifting a vehicle, information about the status of the individual lifting devices and/or its earlier use can be taken into account when selecting lifting devices for a lifting system. For example, battery status of the individual lifting devices is considered for selecting the most appropriate lifting devices for the next lifting operation. For example, this prevents malfunctioning or delay of a lifting operation due to the limited battery status of one of the lifting devices.

In some of the presently preferred embodiments the lifting system comprises a so-called sim-card, or other suitable communication means, to enable communication between the data processing unit of the control system and the lifting data receiving system. This communication operates independently from any local network. Optionally, also communication between the lifting data receiving system and/or other (external) systems, including maintenance systems, is enabled.

The memory in the lifting data receiving system is operatively connected to the data processing unit, preferably comprising at least one processor, wherein the memory is preferably configured to store the measurements received by the second communication module in the respective memory with a time (t) as a timestamp. This enables effective storage of the relevant management data.

In a presently preferred embodiment of the invention the lifting process data comprises data about one or more vehicle types and/or vehicle weight. This makes it possible to link the actual lifting operation with a vehicle type and optionally a specific vehicle. The data may also include the actual load and/or cumulative load since the recent maintenance operation. The load/weight of the vehicle to be lifted may influence the selection of the specific lifting devices. Also, the vehicle identification may enable a pay-per-lift scheme, wherein a vehicle owner or vehicle responsible is paying for the actual lifting operation, preferably taking into account the duration of the lifting operation and/or the actual load on the lifting system.

In a further preferred embodiment of the invention the lifting device status data comprises one or more of a number of lifting operations, energy usage and/or availability, and travel distance of the carrier and/or drive system. Such information can be used in combination with an aforementioned pay-per-lift scheme and/or can be used as a trigger for scheduling a maintenance operation and/or charging operation of a battery of the lifting system.

Optionally, the lifting device status data comprises processed data that is preferably generated by the (local) control system configured for controlling the at least one lifting device. The processed data may involve calculated and/or combined data. One of the advantages of using such processed data is the reduction of data transfer.

In a preferred embodiment of the invention the lifting system further comprises a display that is operatively connected to the lifting data receiving system, and input controls, wherein the display is configured to display information about the data aggregation system and threshold settings, and wherein the input controls are configured to allow a user to adjust the threshold settings.

The display enables exchanging information with an operator/user about the data aggregation system and threshold settings and allowing an adjustment of the threshold settings using the input controls. Such display can be used to exchange information with a user/operator and/or its supervisor.

In one of the presently preferred embodiments of the invention the lifting system comprises one, two or any other suitable number of mobile lifting columns. Tests have shown that the control system with the data aggregation system, and a lifting data receiving system can be advantageously applied to a lifting system with one, two or any other suitable number of mobile lifting columns.

In a presently preferred embodiment of the invention the lifting system further comprises a maintenance control module that is configured for comparing lifting device status data with a maintenance threshold to generate a maintenance message.

The maintenance control module can be a separate controller or can be incorporated in the controller of the lifting system. Lifting device status data may comprise information such as the number of lifting operation and/or distance travelled by a lifting cylinder and/or carrier. This information is typically compared with a maintenance threshold(s) to determine the need for a maintenance operation. Preferably, the maintenance controller is configured for combining lifting process data and lifting device status data to compare combined lifting process data and lifting device status data with a maintenance threshold(s). For example, in a presently preferred embodiment, the travel distance of the lifting cylinder and/or carrier and the energy usage are combined with the load of the individual lifting operation and then compared with one or more maintenance thresholds. According to another example, the multiplication of the actual load with the actual distance of the cylinder and/or carrier that is travelled can be compared with a respective maintenance threshold. Optionally, the cumulative value of this combined data can be monitored in time and compared with the respective maintenance threshold.

In a further preferred embodiment of the invention the lifting system further comprises a selector module for selecting a lifting device, such as a mobile lifting column, for a specific lifting operation, wherein the selector module selects one or more lifting devices with the use of the lifting device status data.

The selector module can be a separate entity or can be integrated within the control system of the lifting system. Optionally, the selector module is provided with information about the vehicle to be lifting and its load. Also preferably, the selector module is provided with information about the status data of the individual lifting devices to enable selecting the most appropriate lifting devices for the lifting system. For example, when using a lifting device having a drive system with a battery the lifting device status data also comprises the battery status data. If the battery status data indicates that the battery is not sufficiently charged the respective lifting device will not be selected by the selector module for the lifting system in the next lifting operation.

### DESCRIPTION OF THE INVENTION

In a presently preferred embodiment of the invention the drive system comprises a battery-charger, and the lifting device status data comprises battery-charger status data. In addition, or as an alternative, in an embodiment of the invention the drive system comprises an energy-generator, and the lifting device status data comprises energy-generator status data. The use of these devices and data further improves the flexibility and operational use of the lifting system.

In a further preferred embodiment of the present invention the lifting system further comprises a warning control module that is configured for comparing lifting device status data and/or lifting process data with a warning threshold to generate a warning message.

The warning control module can be embodied as a separate entity or can be integrated within the control system of the lifting system. The warning message may indicate an unsafe operation that can be caused by an overload of the carrier, for example. This may involve comparing lifting process data and/or lifting device status data involving the actual loads and/or vehicle weight and comparing with a warning threshold. Optionally, also carrier height and/or carrier velocity can be considered when generating a warning message. For example, at specific (high) loads the velocity can be restricted to prevent any unsafe situations. The warning message can be delivered to an operator/user and/or his supervisor. As indicated earlier, the warning message may also involve a locking signal and/or can be followed by a locking signal when an unsafe situation is not resolved within a specific time period. Optionally, in case of generating such locking instruction, the warning control module may also provide an unlocking instruction as soon as the safety is restored again.

In a further preferred embodiment of the present invention the processing of a measurement by the data processing unit of the lifting system comprises:
establishing if the measurement confirms to at least one criterion of a set of criteria;
if the measurement confirms to at least one criterion of the set of criteria:
   at least temporarily storing the measurement in the memory;
   -sending the measurement to the lifting data receiving system using the first communication module;
if the measurement does not confirm to at least one criterion of the set of criteria:
   skipping the measurement;
wherein the set of criteria comprises:
   the measurement has no valid preceding measurement, wherein a valid preceding measurement comprises a youngest corresponding measurement collected at a time (T−1) which confirmed to the set of criteria and was stored in the memory, wherein the time (T−1) denotes the time the youngest corresponding measurement was collected by the data aggregation system;
   the measurement has a valid preceding measurement and
      the time period between (T−1) and (T) exceeds an associated predetermined duration threshold,
      the difference between the value of the measurement and the value of the valid preceding measurement is outside an associated predetermined difference threshold, or
      the value of the measurement is in an associated key value range; and
   wherein the duration threshold, difference threshold and key value range comprise threshold settings stored in the memory.

It is noted that a valid preceding measurement comprises a youngest corresponding measurement collected at a time (T−1) which confirmed to the set of criteria and was stored in the memory, wherein the time (T−1) denotes the time the youngest corresponding measurement was collected by the data aggregation system.

It is further noted that initially, for example at the start of the lifting system, there will be no values stored in the memory, since no data has been collected yet. Alternatively, at the start of the process a default measurement can be stored in the memory, for example a speed of zero when starting the lifting operation with the lifting system.

It is also noted that the set of criteria might also be referred to as criteria. Duration thresholds, difference thresholds and key values stored in the memory may also be referred to as threshold settings. Predetermined threshold settings may be referred to as preset threshold settings. Multiple preset threshold settings may be stored in the memory.

Such processing of measurements reduces the required data transmission in the lifting system according to invention. In fact, data is only transmitted when one or more of the aforementioned criteria is/are met. This reduces the amount of data that is sent and reduces the amount of required bandwidth for sending this data.

The duration threshold criteria ensure that a measurement is sent to the lifting data receiving system at least every time the duration threshold is exceeded. Introducing the duration threshold has the advantage that it is possible to differentiate a malfunctioning sensor that is no longer taking measurements from a sensor which measurements are within the difference threshold for an extended period of time.

The difference threshold criteria ensure that measurements are only sent to the lifting data receiving system when the change in measurement value exceeds the threshold. This has as an advantage that constant measurements or measurements with small fluctuations are not sent. This reduces the total amount of data that is sent via the mobile broadband connection, without the need to lower the data measurement frequency.

The key value criteria ensure that some measurements are always sent to the lifting data receiving system, even if they would normally fall within the difference threshold. This has as advantage, that when the key value has an important meaning attached, this value is always registered in the lifting data receiving system. An example is the carrier velocity. In context the difference between standing still and moving slowly might be of importance when analyzing the data, while the difference in speed might fall within the difference threshold and would therefore not be recorded without setting the key value for speed to zero.

Preferably, the display is configured to display information about the data aggregation system and threshold settings, and also for any input controls that are configured to allow a user to adjust the threshold settings. Optionally, the data processing unit is further configured to select a preset threshold setting from a group of reset threshold settings. This selection can be made taking into account the specific upcoming lifting operation, for example.

In a presently preferred embodiment the difference thresholds comprise a percentage of change between the value of measurement and the preceding value.

The selection of a threshold may also consider the type of vehicle that is to be lifted in the upcoming lifting operation.

Optionally, the threshold settings are dynamically adjusted based on the amount of bandwidth that is available for the first and/or second communication module. This dynamically adjustment may comprise lowering the difference thresholds and duration thresholds when more bandwidth is available and increasing the difference thresholds and duration thresholds when less bandwidth is available. This enables an effective use of the available bandwidth. Preferably, measurements or a collection of measurements are sent to the lifting data receiving system using the first and second communication module at a pre-defined time interval. Such pre-defined time interval can be in the range of 1 to 3 seconds, and more preferably about 2 seconds. It will be understood that any other time interval can also be envisaged in accordance to be present invention.

In a further preferred embodiment the lifting data receiving system is further configured to, if an element is in the memory for a time (T−1) and when a corresponding element lacks in the received measurements collected at time (T), repeat the element in the memory with timestamp (T). This repeating of a measurement value enables the lifting data receiving system to continue with its tasks in case a measurement is not received by it.

The invention further also relates to a method for lifting a vehicle, the method comprising the steps of:
providing a lifting system according to an embodiment of the present invention;
controlling the at least one lifting device with the control system;
collecting a plurality of measurements with the data aggregation system at a time (T);
processing with the data processing unit each measurement from the plurality of measurements from the data aggregation system;
connecting the second communication module to the first communication module of the lifting system for:
   receiving measurements from the at least one lifting device, wherein the measurements comprise lifting device status data; and
   sending instructions to the at least one lifting device, wherein the instructions are determined by comparing the received measurements with one or more thresholds, wherein the instructions comprise at least one or more of a maintenance warning, a warning and/or lock signal, and a selection of one or more lifting devices for the lifting system.

The method provides the same or similar advantages as described in relation to the lifting system. It will be understood that every aspect described for the lifting system can also be used in the method for lifting a vehicle. The method further involves positioning a vehicle to be lifted relative to the lifting system, lifting and lowering the vehicle.

The invention further also relates to a method for operating a control system of a lifting system, with the method comprising the steps of:
collecting, by a control system of at least one lifting device, a plurality of measurements from at least one or more of the following categories:
   height of the carrier;
   velocity of the carrier;
   lifting device status data comprising data relating to the status of a drive system of the at least one lifting device; and
   lifting process data comprising data relating to the lifting operation;
send measurements of the plurality of measurements of the at least one lifting device to a lifting data receiving system;
receive instructions from a lifting data receiving system, wherein the instructions are determined by comparing the received measurements with one or more thresholds, wherein the instructions comprise at least one or more of a maintenance warning, a warning and/or lock signal, and a selection of one or more lifting devices for the lifting system.

The method for operating a control system of a lifting system provides the same or similar advantages as described in relation to the lifting system and/or the method for lifting a vehicle.

The method preferably also comprises the step of executing the instructions that are received by the lifting data receiving system. This provides an operational system. By operating the control system a vehicle can be lifted.

The invention further also relates to a method for operating a lifting data receiving system of a lifting system with the method comprising the steps of:
receiving measurements of a plurality of measurements of at least one lifting device, wherein the measurements are collected by a control system of the at least one lifting device, wherein the plurality of measurements is at least one or more of the following categories:
   height of the carrier;
   velocity of the carrier;
   lifting device status data comprising data relating to the status of a drive system of the at least one lifting device; and
   lifting process data comprising data relating to the lifting operation;
sending instructions to the at least one lifting device, wherein the instructions are determined by comparing the received measurements with one or more thresholds, wherein the instructions comprise at least one or more of a maintenance warning, a warning and/or lock signal, and a selection of one or more lifting devices for the lifting system.

The method for operating a control system of a lifting system and operating a lifting data receiving system of a lifting system provide the same or similar effects and more advantages as described in relation to a lifting system and the associated method for lifting a vehicle. By operating a lifting data receiving system a vehicle can be lifted.

### BRIEF DESCRIPTION OF THE DRAWINGS

The terms Fig., Figs., Figure, and Figures are used interchangeably in the specification to refer to the corresponding figures in the drawings.

Further advantages, features and details of the invention are elucidated on the basis of preferred embodiments thereof, wherein reference is made to the accompanying drawings, in which:

FIG. 1 shows a schematic overview of a lifting system according to the present invention;

FIG. 2 shows a lifting system with mobile lifting columns in accordance with FIG. 1;

FIGS. 3-6 illustrate alternative lifting systems according to the present invention.

The following description is merely exemplary in nature and is in no way intended to limit the invention, its application, or uses. While the disclosure is described as having exemplary attributes and applications, the present disclosure can be further modified. This application is therefore intended to cover any variations, uses, or adaptations of the disclosure using its general principles. Further, this application is intended to cover such departures from the present disclosure as come within known or customary practice of those skilled in the art to which this disclosure pertains and which fall within the limits of the appended claims. Accordingly, the following description of certain embodiments and examples should be considered merely exemplary and not in any way limiting.

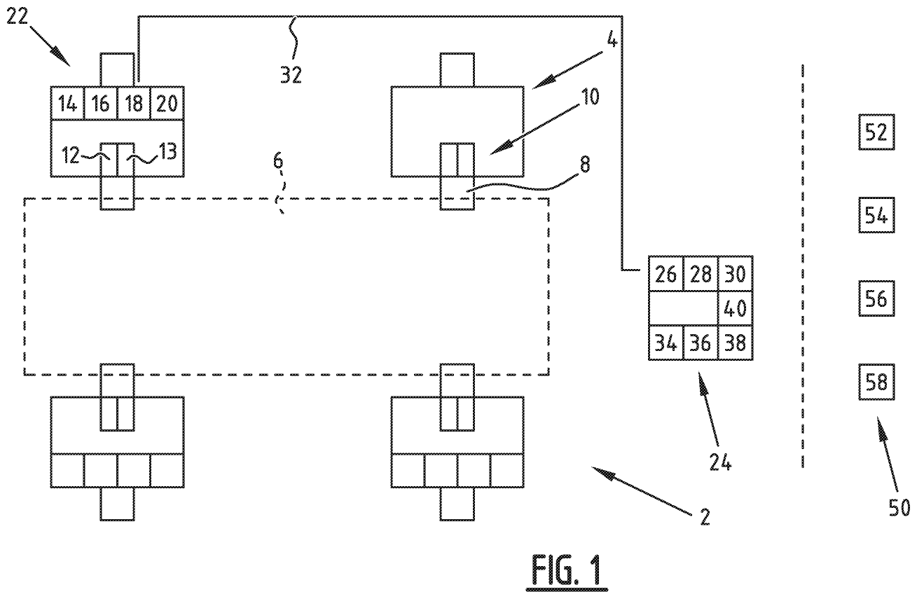

Lifting system 2 (FIG. 1) relates to a lifting system with several mobile lifting columns 4 capable of lifting vehicle 6 from a workshop floor. Each lifting column 4 comprises carrier 8 that is configured for engaging vehicle 6 and drive system 10 with battery 12 and cylinder 13. Each mobile lifting column 4 is further provided with data aggregation system 14, data processor 16, memory 18 and first communication module 20 that together define control system 22 in this illustrated embodiment.

Lifting system 2 further comprises lifting data receiving system 24 comprising second communication module 26, memory 28 and processor 30. First communication module 20 sends and receives data and/or instructions 32 to/from second communication module 26. Such data/instructions 32 can be sent in two directions. The lifting data receiving system 24 can be incorporated in one or all of lifting devices 4 or can be provided as a separate entity.

In the illustrated embodiment, lifting data receiving system 24 is further provided with maintenance control module 34, selector module 36, and warning control module 38. Preferably, there is also provided data reduction module 40.

Maintenance control module 34 uses data 32 to determine the need for a maintenance operation. Selector module 36 uses data to select or suggest one or more lifting devices 4 to be used in lifting system 2 in the selection phase of the lifting operation. Warning control module 38 uses data 32 to generate a warning in case of (possible) unsafe working situations. Data reduction module 40 adjusts the amount of data 32 and brings the amount in accordance with the actual needs and/or possibility in view of available bandwidth.

External systems 50 receive information from and send information to lifting data receiving system 24. These external systems may relate to manufacturer system 52, sales system 54, service system 56 and/or workshop system 58 and/or any other suitable system. Manufacturer system 52 enables a manufacturer to monitor lifting system 2. For example, this may enable repair or error analysis by the manufacturer of the lifting system. Sales system 54 enables monitoring of the actual use of lifting system 2 and provides any updates, including software updates of lifting system 2. Service system 56 may schedule maintenance operations on the basis of data received by lifting data receiving system 24. Workshop system 58 may calculate an effective logistic schedule or job schedule for lifting system 2 using data 33.

Next, some examples will be presented that illustrate some possibilities with the lifting system and associated methods.

Maintenance control module 34 may determine a need for maintenance operation on the basis on the actual usage of lifting system 2. For example, the actual load can be multiplied with the travel distance of a cylinder and/or carrier of the lifting system and can be accumulated for the series of lifting operations. After exceeding a maintenance threshold, a maintenance instruction can be generated by maintenance control module 34.

Selector module 36 may suggest or select a suitable lifting device 4 from the available lifting devices that is capable of performing the upcoming lifting operation. This may involve the use of battery status of battery 12 for example. It may also combine the cumulative value for the load versus travelled distance and/or number of lifting operations that already have been performed et cetera.

Warning control module 38 may generate a (safety) warning when the load exceeds a warning threshold. In addition, or alternatively, a warning can also be generated by warning control module 38 or a combination of a load with a specific velocity. For example, a load with low velocity may be acceptable while the same load at a higher velocity can be unacceptable for safety reasons. In such case warning control module 38 may control a warning instruction. In the illustrated embodiment lifting system 2 generates a warning when the load of vehicle 6 exceeds a respective threshold. This prevents any overload and/or unsafe working situation. Optionally, in case of such an overload situation not being resolved within a specific time period a locking instruction can be generated by the warning control module 38 that may optionally lock lifting system 2 for further use until the overload situation is resolved.

Data reduction module 40 is manipulating data transfer between first and second communication modules 20, 26 on a basis of settings.

In one of the embodiments lifting system 2 receives data of the travelled distance of carrier 8 and/or cylinder 13. For illustrative purposes an example is given for times T=1 to T=4. Data processing unit 16 is configured to use a predetermined difference threshold of 0.5 millimeters for said measurements. In the table below a sequence of measurements is given, indicating their value, and the observation whether or not the measurement is sent by communication module 20 to lifting data receiving system 24. Also for illustrative purposes, a (dynamic) difference threshold range is also displayed in the table such that it is easy to see when the difference between the value of the measurement and the value of the valid preceding measurement is outside such predetermined difference threshold. The measurement at T=1 is sent since it is the first measurement in the sequence and thus has no valid preceding measurement. The measurement at T=2 is sent since the value is outside the difference threshold range. The measurement at T=3 is not sent, since it is in the (dynamic) range. The measurement at T=4 is sent since it outside the range.

| Time T | Distance (mm) | Sent | Threshold Range |
|---|---|---|---|
| 1 | 0 | Yes | 0-0.5 |
| 2 | 0.5 | Yes | 0-1 |
| 3 | 0.6 | No | |
| 4 | 1 | Yes | 0.5-1.5 |

In another example of the invention the velocity of carrier 8 is registered in mm/seconds, using a predetermined difference threshold of 1 mm/sec and a key value of 0 mm/sec.

| Time T | Speed (mm/sec) | Sent | Threshold range |
|---|---|---|---|
| 1 | 8 | Yes | 7-9 |
| 2 | 8.5 | No | |
| 3 | 10 | Yes | 9-11 |
| 4 | 0 | Yes | −1-1 |

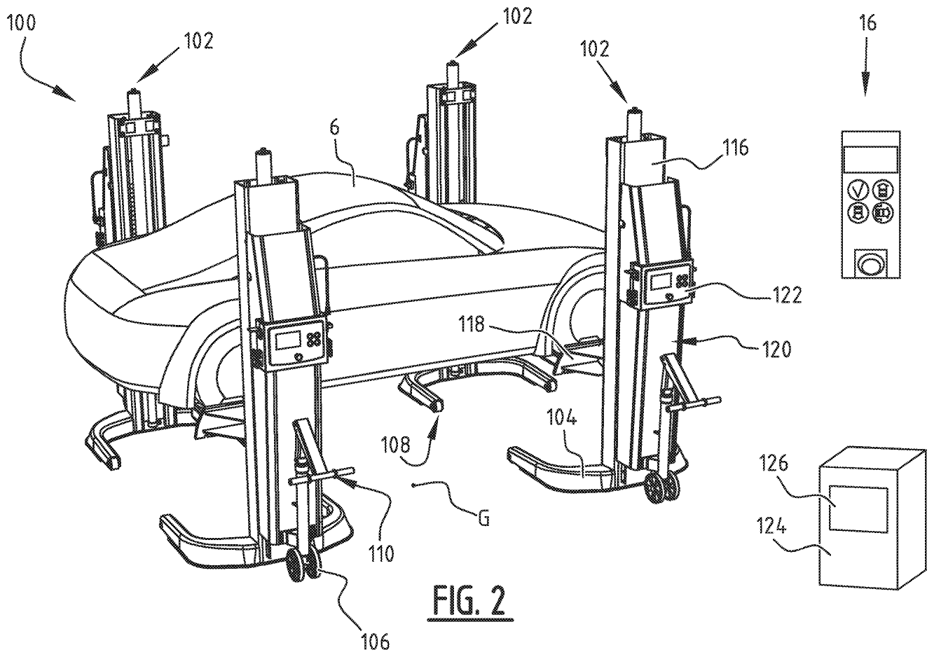

Lifting system 100 comprises a set of four lifting devices 102 (FIG. 2). Lifting columns 102 lift passenger car 6 from ground/workshop floor G. In the illustrated embodiment lifting columns 102 are connected to each other by wireless communication means. Lifting columns 102 comprise foot 104 which can travel on running wheels 106 over ground surface G or for instance a floor of a garage or workshop. In the forks of foot 104 there is provided additional running wheel 108. Running wheel 106 is part of pallet truck mechanism 110 that enables easy maneuvering of mobile lifting column 102. Lifting column 102 further comprises mast 116 and carrier 118 that is movable up downward along mast 116. Carrier 118 is driven by motor/drive system 120. Optionally, remote control 17 is provided.

In the illustrated embodiment each lifting column 102 is provided with local controller 122 that allows a user to control lifting system 100, and acts as control system 22 as shown in FIG. 1. In the illustrated embodiment separate lifting data receiving system 124 with optional display 126 is provided. Lifting data receiving system 124 preferably corresponds to lifting data receiving system 24 as shown in FIG. 1.

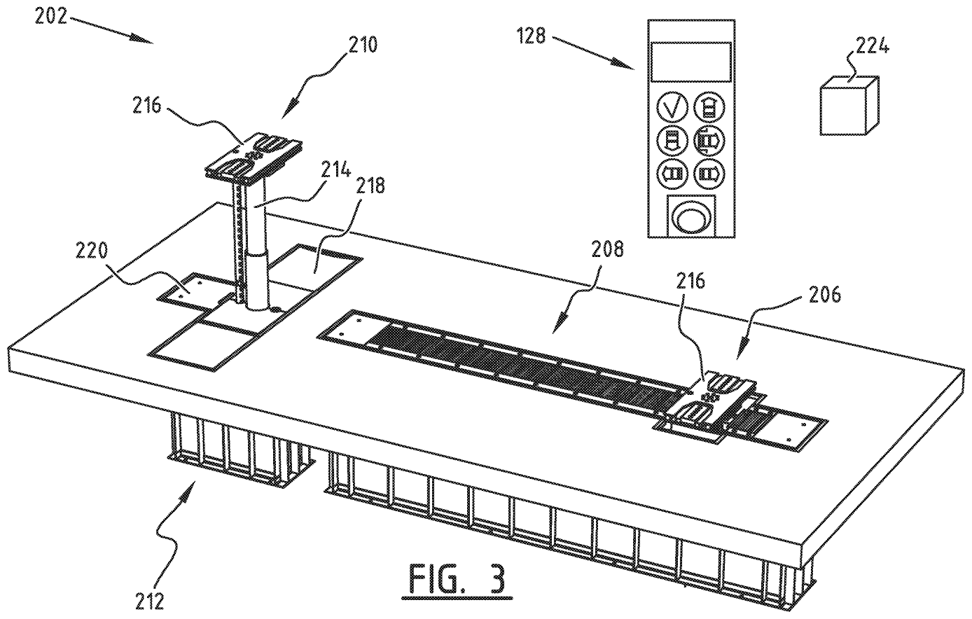

In-ground lift 202 (FIG. 3) is used to lift vehicle 6 and comprises one or more moveable lifts 206 that can be moved in pit 208. In the illustrated embodiment stationary lift 210 is provided in cassette or box 212 with telescopic lifting cylinder 214. Carriers 216 can carry vehicle 6. In the illustrated embodiment wheel hatches or wheel recesses 218 are provided as well as hatch 220 for maintenance or inspection, for example. Remote control 128 can be used for controlling lifting system 202. Lifting data receiving system 224 preferably corresponds to lifting data receiving system 24 as shown in FIG. 1. Also, in the illustrated embodiment lifting system 202 comprises remote control 128. Furthermore, it will be understood that a controller 124 capable of controlling multiple lifting devices 102 can be provided as a separate controller and/or similar control functions can be incorporated in local controller 122 that also can be used to control the other lifting devices 102 in lifting system 100 and acts as control system 22 as shown in FIG. 1. In the illustrated embodiment in-ground lift 202 is of piston-type. Alternatively, a scissor type lift can be provided.

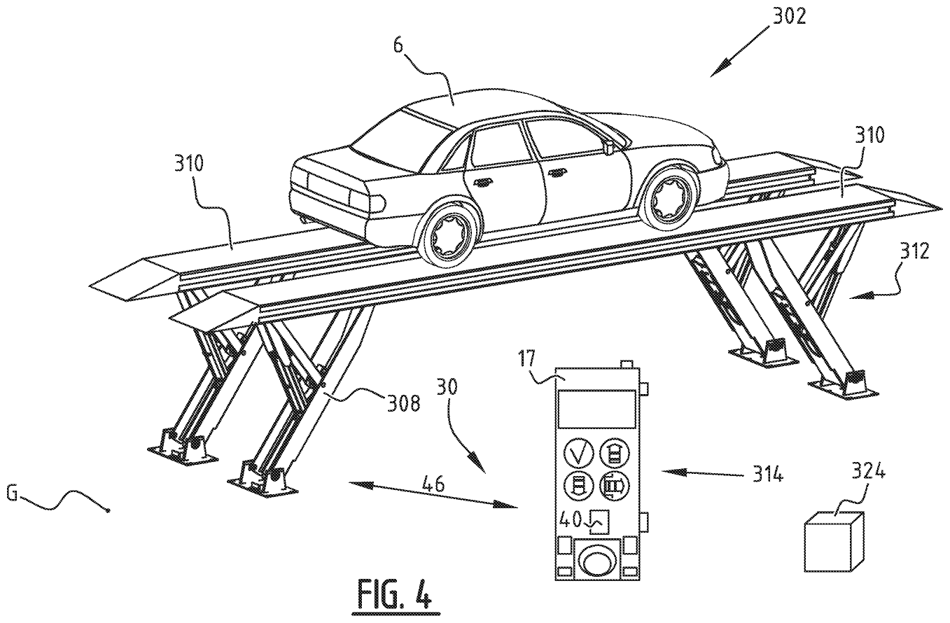

Lifting device 302 (FIG. 4) relates to a so-called sky lift type lifting device. Lifting device 302 is capable of lifting vehicle 6 from ground surface G. In the illustrated embodiment lifting device 302 comprises four legs 308 and two carriers 310. Cylinder 312 acts as the drive for lifting device 302. Controller 314 is schematically illustrated and comprises control parts for lifting device 302. In addition, in the illustrated embodiment controller 314 is integrated with remote control 17 and acts as control system 22 as shown in FIG. 1. Lifting data receiving system 324 preferably corresponds to lifting data receiving system 24 as shown in FIG. 1.

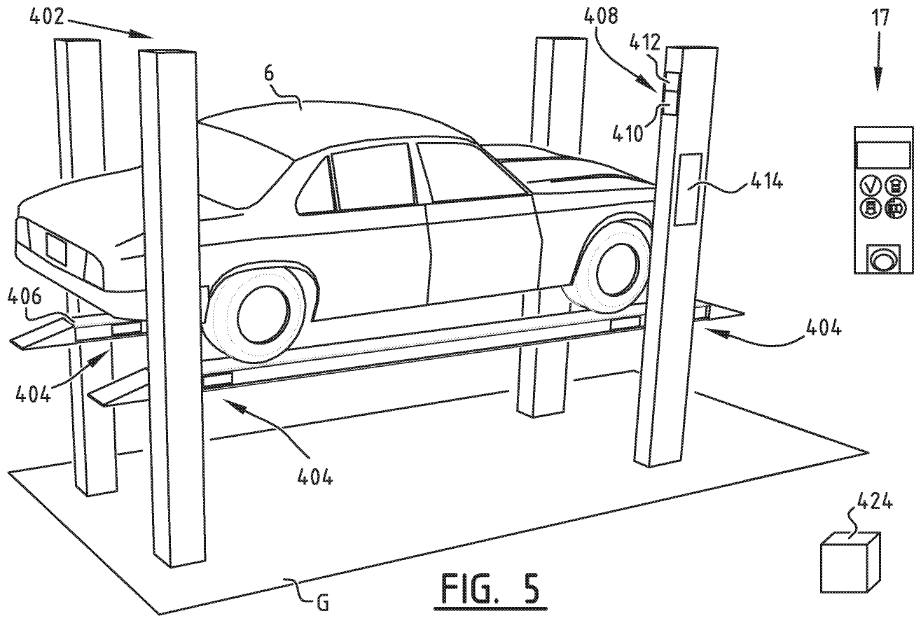

Lifting device 402 (FIG. 5) is of a four-post type and comprises four columns 404 and carrying runways 406. In the illustrated embodiment there is provided indicator 408 with green light 410, red light 412 to signal a driver when vehicle 6 is positioned correctly relative to columns or posts 404 and vehicle 6 can be lifted from ground G, for example. Remote control 17 may communicate with local controller 414 that can raise and/or lowering runways 406 and acts as control system 22 as shown in FIG. 1. Lifting data receiving system 424 preferably corresponds to lifting data receiving system 24 as shown in FIG. 1.

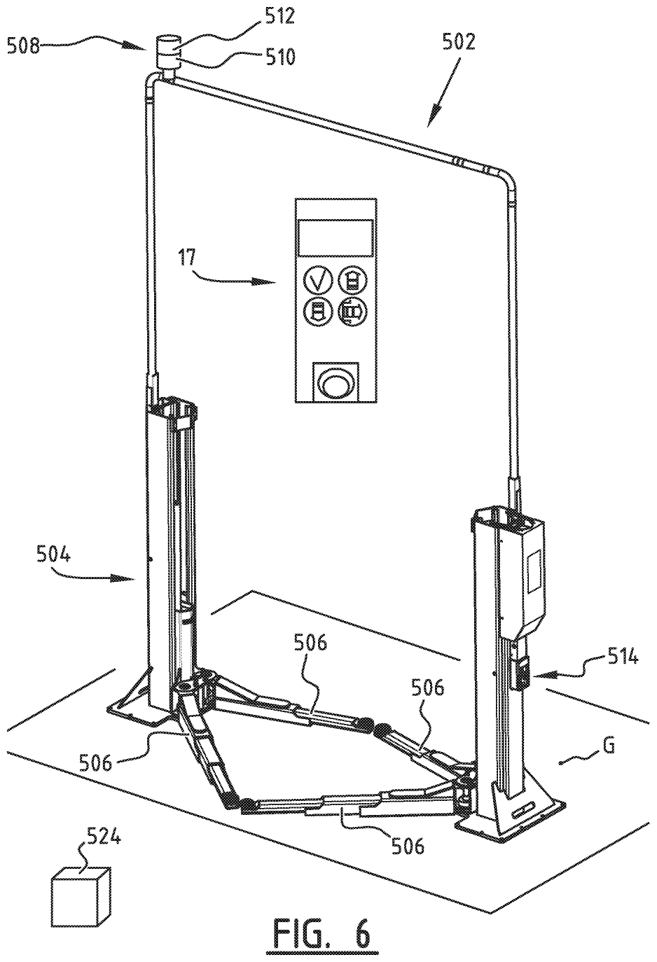

Lifting device 502 (FIG. 6) can be controlled using remote control 17, for example. This two-post lifting device 502 comprises two posts 504 that are provided with carrier arms 506. Optionally, light 508 with green light 510 and red light 512 can be provided to indicate to a driver or vehicle 4 that the vehicle is positioned correctly or needs to be repositioned. Local controller 514 acts as control system 22 as shown in FIG. 1 and can be coupled to remote control 17. Lifting data receiving system 524 preferably corresponds to lifting data receiving system 24 as shown in FIG. 1.

It will be understood that the invention can be applied to a range of lifting devices and lifting systems, including but not limited to four-post and two-post lifting columns, such as the Stertil-Koni mobile column lifts ST1075, the Stertil-Koni two post lifts SK 2070, and the Stertil-Koni four post lifts ST 4120, skylift, mobile columns, and in-ground lifts, such as the Stertil in-ground Ecolift and the Stertil in-ground Diamond lift. Also, it will be understood that additional embodiments of the invention can be envisaged combining and/or switching features from the described and/or illustrated embodiments. For example, remote controls 17, 128 can optionally be applied to all different lifting devices and lifting systems.

The present invention is by no means limited to the above-described preferred embodiments thereof. The rights sought are defined by the following claims within the scope of which many modifications can be envisaged.

1. A lifting system for lifting a vehicle, the lifting system comprising:
at least one lifting device with a carrier and a drive system configured for lifting the vehicle;
a control system configured for controlling the at least one lifting device, with the control system comprising:
a data aggregation system configured to collect a plurality of measurements at a time (T) from at least one or more of the following categories:
height of the carrier;
velocity of the carrier;
lifting device status data comprising data relating to the status of the drive system of the at least one lifting device; and
lifting process data comprising data relating to the lifting operation;
a data processing unit that is operatively connected to the data aggregation system, wherein the data processing unit is configured to process each measurement of the plurality of measurements from the data aggregation system;
a memory that is operatively connected to the data processing unit;
a first communication module operatively connected to the data processing unit; and
a lifting data receiving system comprising a processor, a memory operatively connected to the processor and a second communication module operatively connected to the processor, wherein the second communication module is configured to connect to the first communication module of the lifting system and is configured to:
receiving one or more measurements of the plurality of measurements from the at least one lifting device; and
sending instructions to the at least one lifting device, wherein the instructions are determined by comparing the received measurements with one or more thresholds, wherein the instructions comprise at least one or more of a maintenance warning, a warning and/or lock signal, and a selection of one or more lifting devices for the lifting system.

2. The lifting system according to claim 1, wherein the lifting process data comprises one or more of a vehicle type, a vehicle identification, and a vehicle weight.

3. The lifting system according to claim 1, wherein the lifting device status data comprises one or more of a number of lifting operations, energy usage and/or availability, and a travel distance of the carrier and/or drive system.

4. The lifting system according to claim 1, further comprising a display that is operatively connected to the lifting data receiving system and input controls, wherein the display is configured to display information about the data aggregation system and threshold settings, and wherein the input controls are configured to allow a user to adjust the threshold settings.

5. The lifting system according to claim 1, wherein the lifting device comprises at least one mobile lifting column.

6. The lifting system according to claim 1, further comprising a maintenance control module configured for comparing lifting device status data and/or lifting process data with a maintenance threshold to generate a maintenance message.

7. The lifting system according to claim 1, wherein the maintenance controller is configured for combining lifting process data and lifting device status data and comparing the combined lifting process data and lifting device status data with the maintenance threshold or wherein the drive system comprises a lifting cylinder, and wherein the lifting device status data comprises the distance travelled by the lifting cylinder of the drive system.

8. (canceled)

9. The lifting system according to claim 1, further comprising a selector module for selecting a lifting device, such as a mobile lifting column, for a lifting operation, wherein the selector module selects one or more lifting columns with the use of the lifting device status data wherein the drive system comprises a battery, and the lifting device status data comprises battery status data.

10. (canceled)

11. The lifting system according to claim 9, wherein the drive system comprises a battery-charger, and the lifting device status data comprises battery-charger status data and/or wherein the selector module selects one or more lifting devices with the use of lifting proses data and/or lifting device status data and/or wherein the selector module selected one or more lifting devices with the use of lifting process data and/or lifting device status data.

12-13. (canceled)

14. The lifting system according to claim 1, further comprising a warning control module that is configured for comparing lifting device status data with a warning threshold to generate a warning message.

15. The lifting system according to claim 10, wherein the lifting system comprises a lock configured for preventing use of the lifting system, and wherein the warning message comprises a locking instruction and/or wherein the warning control module is configured for combining lifting process data and lifting device status data and comparing with the warning threshold.

16. (canceled)

17. The lifting system according to claim 15, wherein processing a measurement by the data processing unit comprises:
establishing if the measurement confirms to at least one criterion of a set of criteria;
if the measurement confirms to at least one criterion of the set of criteria:
at least temporarily storing the measurement in the memory;
sending the measurement to the lifting data receiving system using the first communication module;
if the measurement does not confirm to at least one criterion of the set of criteria:
skipping the measurement;
wherein the set of criteria comprises:
the measurement has no valid preceding measurement, wherein a valid preceding measurement comprises a youngest corresponding measurement collected at a time (T−1) which confirmed to the set of criteria and was stored in the memory, wherein the time (T−1) denotes the time the youngest corresponding measurement was collected by the data aggregation system;
the measurement has a valid preceding measurement and
the time period between (T−1) and (T) exceeds an associated predetermined duration threshold,
the difference between the value of the measurement and the value of the valid preceding measurement is outside an associated predetermined difference threshold, or
the value of the measurement is in an associated key value range; and
wherein the duration threshold, difference threshold and key value range comprise threshold settings stored in the memory.

18. The lifting system according to the claim 17, wherein the data processing unit is further configured to select a preset threshold setting from a group of preset threshold settings wherein the difference thresholds comprises a percentage of change between the value of the measurement at time (T) and the value of the valid preceding measurement at a time (T−1) and/or wherein the data processing unit is further configured to select a preset threshold setting from a group of preset threshold settings based on the type of vehicle.

19-20. (canceled)

21. The lifting system according to claim 17, wherein the data processing unit is further configured to dynamically adjust the threshold settings based on the amount of bandwidth available via the first and/or second communication module, wherein dynamically adjusting comprises lowering the difference thresholds and duration thresholds when more bandwidth is available and increasing the difference thresholds and duration thresholds when less bandwidth is available.

22. The lifting system according to claim 17, wherein the data processing unit is further configured to send a collection of measurements that comply with the criteria to the lifting data receiving system using the communication unit at a pre-defined interval, wherein the pre-defined interval is in the range of 1-3 seconds, and is preferably about 2 seconds.

23. (canceled)

24. The lifting system according to claim 17, wherein the lifting data receiving system is further configured to:
if an element is in the memory for a time (T−1) and when a corresponding element lacks in the received measurements collected at time (T), repeat the element in the memory with timestamp (T).

25. A method for lifting a vehicle, the method comprising the steps of:
providing a lifting system comprising:
at least one lifting device with a carrier and a drive system configured for lifting the vehicle;
a control system configured for controlling the at least one device, with the control system comprising:
a data aggregation system configured to collect a plurality of measurements at a time (T) from at least one or more of the following categories:
height of the carrier;
velocity of the carrier;
lifting device status data comprising data relating to the status of the drive system of the at least one lifting device, and
lifting process data comprising data relating to the lifting operation;
a data processing unit that is operatively connected to the data aggregation system, wherein the data processing unit is configured to process each measurement of the plurality of measurements from the data aggregation system;
a memory that is operatively connected to the data processing unit;
a first communication module operatively connected to the data processing unit; and
a lifting data receiving system comprising a processor, a memory operatively connected to the processor and a second communication module operatively connected to the processor, wherein the second communication module is configured to connect to the first communication module of the lifting system and is configured to:
receiving one or more measurements of the plurality of measurements from the at least one lifting device; and
sending instructions to the at least one lifting device, wherein the instructions are determined by comparing the received measurements with one or more thresholds, wherein the instructions comprise at least one or more of a maintenance warning, a warning and/or lock signal, and a selection of one or more lifting devices for the lifting system;
wherein the method further comprising:
controlling the at least one lifting device with the control system;
collecting a plurality of measurements with the data aggregation system at a time (T);
processing with the data processing unit each measurement from the plurality of measurements from the data aggregation system;
connecting the second communication module to the first communication module of the lifting system for:
receiving measurements from the at least one lifting device, wherein the measurements comprise lifting device status data; and
sending instructions to the at least one lifting device, wherein the instructions are determined by comparing the received measurements with one or more thresholds, wherein the instructions comprise at least one or more of a maintenance warning, a warning and/or lock signal, and a selection of one or more lifting devices for the lifting system.

26. The method according to claim 25, further comprising the step of operating a control system of a lifting system, the method comprising the steps of:
collecting, by a control system of at least one lifting device, a plurality of measurements from at least one or more of the following categories:
height of the carrier;
velocity of the carrier;
lifting device status data comprising data relating to the status of a drive system of the at least one lifting device; and
lifting process data comprising data relating to the lifting operation;
send measurements of the plurality of measurements of the at least one lifting device to a lifting data receiving system;
receive instructions from a lifting data receiving system, wherein the instructions are determined by comparing the received measurements with one or more thresholds, wherein the instructions comprise at least one or more of a maintenance warning, a warning and/or lock signal, and a selection of one or more lifting devices for the lifting system.

27. The method according to the claim 26, further comprising:
executing the instructions that are received by the lifting data receiving system.

28. A method for operating a lifting data receiving system of a lifting system, comprising:
receiving measurements of a plurality of measurements of at least one lifting device, wherein the measurements are collected by a control system of the at least one lifting device, wherein the plurality of measurements are at least one or more of the following categories:
height of the carrier;
velocity of the carrier;
lifting device status data comprising data relating to the status of a drive system of the at least one lifting device; and
lifting process data comprising data relating to the lifting operation;
sending instructions to the at least one lifting device, wherein the instructions are determined by comparing the received measurements with one or more thresholds, wherein the instructions comprise at least one or more of a maintenance warning, a warning and/or lock signal, and a selection of one or more lifting devices for the lifting system.
